(19) United States
(12) Patent Application Publication
(10) Pub. No.: US 2024/0202271 A1
(43) Pub. Date: Jun. 20, 2024

(54) CREDENTIAL ENABLED REFERENCE FOR EXTERNAL RESOURCE ACCESS

(71) Applicant: Laboratory Corporation of America Holdings, Burlington, NC (US)

(72) Inventors: Enno de Vries, Tower Lakes, IL (US); Susan Donahue, Burlington, NC (US); Chris Banno, Burlington, NC (US); Gaurav Sharma, Burlington, NC (US)

(21) Appl. No.: 18/541,381

(22) Filed: Dec. 15, 2023

Related U.S. Application Data
(60) Provisional application No. 63/387,856, filed on Dec. 16, 2022.

(51) Int. Cl. G06F 16/958; G06F 3/04817; G06F 16/957; H04L 9/40

(52) U.S. Cl. CPC G06F 16/972; G06F 3/04817; G06F 16/9577; H04L 63/102

(57) ABSTRACT

A computing environment can provide secure downloadable content regarding diagnostic test results to authorized and authenticated users. For example, a method disclosed herein can include receiving a diagnostic testing order for performing one or more tests. The method can also include generating downloadable content displaying test results. The method can further include generating a reference to a web resource including the downloadable content. Additionally, the method can include associating the reference with authorized users. The method can include delivering the reference for access by authorized users. The method can also include receiving a request for access to the web resource. Additionally, the method can include confirming the request is from an authenticated user. The method can further include confirming the request is from one of the authorized users. The method can include providing access to the web resource including the downloadable content to the authenticated and authorized user.

### CROSS-REFERENCE TO RELATED APPLICATION

This application claims priority to U.S. Provisional Patent Application No. 63/387,856, filed on Dec. 16, 2022, entitled “CREDENTIAL ENABLED REFERENCE FOR EXTERNAL RESOURCE ACCESS” which is hereby incorporated by reference in its entirety.

### FIELD

The present disclosure relates to a method and system for creating and providing a credential enabled reference for external resource access.

### BACKGROUND

A significant portion of proprietary record managing systems in various industries may not receive certain file formats from third party service providers. There can be numerous reasons why the proprietary record managing systems are not designed to receive files from third party services providers. Restrictions can be due to infrastructure limitations, or infrastructure can be intentionally constructed in that manner. An example of an infrastructural limitation may include complexities of integrating a legacy system with newer technologies. In some examples, operators of proprietary record managing systems can purposely restrict file transfers from third parties to mitigate risk related to privacy, security, etc. or to prevent the record managing systems from becoming overwhelmed with an excessive amount of data when receiving a high volume of files. Frequently, in certain industries (e.g., healthcare) instead of providing information through electronic files, third party service providers can be required to send files and other information through older methodologies such as physical mail, fax, etc. Such older methodologies can have some shortcomings such as a potential to delay receiving information, potential to lose information entirely, or potentially exposing information to unintended parties.

In an example, healthcare providers can have databases for storing electronic medical records (EMR) or electronic health records (EHR) that are digital versions of patient charts and/or patient histories. EMR/EHR software can be designed to assist healthcare providers with managing medical records for patients and occasionally automate aspects of patient treatment. For example, EMR/EHR software can allow healthcare providers to automate clinical workflows, efficiently create and maintain notes during patient visits, generate reports on treatments, best practices, and compliance with regulations, communicate with patients and staff, provide remote telemedicine, prescribe and track medications, manage billing, etc. in a single application or application suite.

Electronic medical records can provide a significant improvement over previously relied upon paper-based methods. However, EMR/EHR software may not be designed to be compatible or be adaptable to work with third party software systems, specifically third-party software provided by service providers. Healthcare practitioners may frequently contract out services to third parties, for example, lab testing on specimens, but EMR/EHR systems may not be equipped to receive and/or display the resulting services (e.g., test results). Instead, service providers can be required to email, fax, mail, etc. copies of their services to the healthcare practitioners, to be viewed outside of the EMR/EHR software. For example, a third-party lab might have to email or mail test results to a healthcare practitioner, who then must access the results separately from the rest of patient information stored in the EMR/EHR.

### SUMMARY OF THE INVENTION

A computing environment can provide secure downloadable content regarding diagnostic test results to authorized and authenticated users. For example, a method disclosed herein can include receiving a diagnostic testing order for performing one or more tests. The method can also include generating downloadable content displaying test results. The method can further include generating a reference to a web resource including the downloadable content. Additionally, the method can include associating the reference with authorized users. The method can include delivering the reference for access by authorized users. The method can also include receiving a request for access to the web resource. Additionally, the method can include confirming the request is from an authenticated user. The method can further include confirming the request is from one of the authorized users. The method can include providing access to the web resource including the downloadable content to the authenticated and authorized user.

In another example, a system described herein can include one or more processors. The system can also include one or more memories. The one or more memories can include instructions executable by the one or more processors to perform operations. The operations can include receiving a diagnostic testing order for performing one or more tests. The operations can also include generating downloadable content displaying test results obtained from performing the one or more tests. The operations can further include generating a reference to a web resource including the downloadable content. Additionally, the operations can include associating the reference with authorized users permitted to access the test results. The operations can include delivering the reference for access by authorized users. The operations can also include receiving a request for access to the web resource. Additionally, the method can include authenticating an identity of the requesting user. The method can further include authorizing the requesting user. The method can include providing access to the web resource including the downloadable content to the authenticated and authorized user.

In another example, a non-transitory computer-readable medium described herein can include instructions executable by the one or more processors to perform operations. The operations can include receiving a diagnostic testing order for performing one or more tests. The operations can also include generating downloadable content displaying test results obtained from performing the one or more tests. The operations can further include generating a reference to a web resource including the downloadable content. Additionally, the operations can include associating the reference with authorized users permitted to access the test results. The operations can include delivering the reference for access by authorized users. The operations can also include receiving a request for access to the web resource. Additionally, the method can include authenticating an identity of the requesting user. The method can further include authorizing the requesting user. The method can include providing access to the web resource including the downloadable content to the authenticated and authorized user.

### BRIEF DESCRIPTION OF THE DRAWINGS

FIG. 1 is a block diagram of a system for providing access to external resources through a credential enabled reference in accordance with various embodiments.

FIGS. 2A, 2B, and 2C are example configuration screens for implementing the method and system in accordance with various embodiments.

FIG. 3 is a block diagram for creating a reference for use in an external resource access system in accordance with various embodiments.

FIG. 4 is a flow diagram for creating a reference for use in an external resource access system in accordance with various embodiments.

FIG. 5 is a block diagram for accessing content using a credential enabled reference in an external resource access system in accordance with various embodiments.

FIG. 6 is a flow diagram for accessing content using a credential enabled reference in an external resource access system in accordance with various embodiments.

FIG. 7 is an illustration for operation of a credential enabled reference for an external resource access system in accordance with various embodiments.

FIG. 8 is an example basic report provided in an external resource access system in accordance with various embodiments.

FIGS. 9A and 9B are example comprehensive reports provided in an external resource access system in accordance with various embodiments.

FIG. 10 is a block diagram of a computing device for use in an external resource access system in accordance with various embodiments.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

The present disclosure relates to a method and system for creating, sharing, and accessing a credential enabled reference for access to an external resource having downloadable content. The credential enabled reference can provide multiple levels of protection to ensure that privacy and/or security of the downloadable content is guaranteed. To provide the multiple levels of protection, an authentication process and authorization process can be implemented. For example, the present disclosure describes techniques for creating, sharing, and accessing a credential enabled reference such as a uniform resource locator (URL) link for a webpage containing downloadable content for viewing using a web browser. The URL can be protected. Before accessing content at the URL, a user can first provide sufficient information (e.g., credentials) to authenticate the user and confirm that the user is authorized to access the content at the webpage. For the purposes of this disclosure, the term authentication can describes a process of verifying an identity of a user (e.g., user credentials/login), whereas the term authorization can describe a process of verifying specific applications, files, and data a user has access to (e.g., allowed to view). In other words, authentication can mean confirming who a user is and authorization can mean confirming what the user is allowed to do or view.

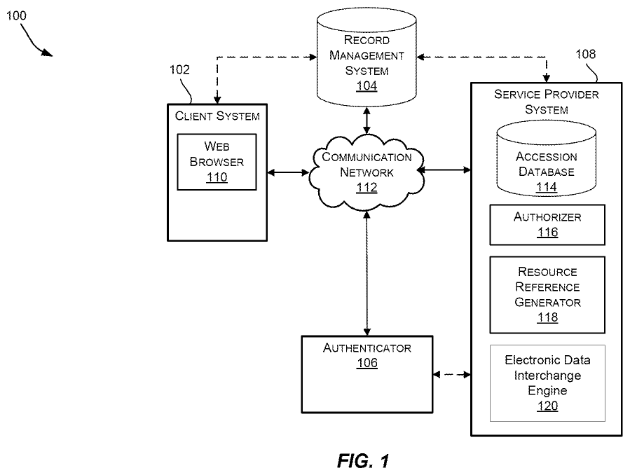

FIG. 1 depicts an illustrative system 100 for implementing the steps in accordance with the aspects of the present disclosure. In particular, FIG. 1 depicts a system 100 including a client system 102, a record management system 104, authenticator 106, and a service provider system 108. Each of the client system 102, the record management system 104, the service provider system 108, and the authenticator 106 can include a combination of hardware and software configured to carry out aspects of the present disclosure. In particular, the client system 102, the record management system 104, the authenticator 106, and the service provider system 108 can include a computing system with specialized software and databases designed for providing a method for providing a credential enabled weblink for external resource access. As would be appreciated by one skilled in the art, each of the client system 102, the record management system 104, the authenticator 106, and the service provider system 108 can include a single computing device, a collection of computing devices in a network computing system, a cloud computing infrastructure, or a combination thereof. For example, the computing devices can include any combination of servers, personal computers, laptops, tablets, smartphones, etc. In some embodiments, different components or elements of the client system 102, the record management system 104, the authenticator 106, and the service provider system 108 can include their own computing devices. For example, the authorizer 116 can be a separate computing device from the service provider system 108 that is communicatively attached to the service provider system 108.

In some embodiments, the client system 102 can include a computing device having software installed thereon for accessing data provided by the other components within the system 100. For example, the client system 102 can include a computing device having a web browser 110 configured for reading references to access web pages and downloading content on a network such as the Internet. The client system 102 can also be configured to be communicatively coupled to the record management system 104 and can include software for accessing, reading, writing, etc. data on the record management system 104. The client system 102 can either access the record management system 104 through the communication network(s) 112, through direct coupling to the record management system 104, or both.

The record management system 104 can include any combination of computing devices configured to store and organize a collection of data. For example, record management system 104 can be a local storage device on the client system 102, a remote database facility, or a cloud computing storage environment. The record management system 104 can also include a database management system utilizing a given database model configured to interact with a user for analyzing the database data. In some embodiments, the record management system 104 includes electronic medical records (EMR) and/or electronic health records (EHR) and software to manage and access the EMR/EHR. The record management system 104 may be a proprietary or specialized system that has targeted functionality depending on needs of the user/industry. For example, EMR/EHR systems can frequently limit a number or type of files received from third party service providers, such as portable document format (PDF) files from third parties (e.g., service provider system 108). In alternative embodiments, the record management system 104 can share and/or receive some data with third parties, such as the authenticator 106 and the service provider system 108.

In some embodiments, the authenticator 106 provides a security protocol acting as a gateway to allow or deny different users from accessing a particular system, application, etc. For example, the authenticator 106 can be provided on or otherwise interact with a landing page that prompts a user to enter requested information to validate the user, prior to providing access to one or more components or features within the system 100. A user login can include any combination of information that can validate an identity of a user. For example, a user login can include a username and password pair, a one-time authentication pin or token, the use of an authentication application, submission of one or more biometrics, or a combination thereof. The authenticator 106 can require single authentication (e.g., username/password) or multi-factor authentication (e.g., username/password and one time token). Once the user has provided appropriate information, the authenticator 106 can confirm the information is valid and provide or deny access to the requested service or webpage. In some embodiments, the authenticator 106 implements a single sign on (SSO) token that is used to validate a request and authenticate a user and keep the user authenticated for a predetermine period of time. For example, once a user is validated as an authentic user, they can re-access the login page and can automatically access the requested information without having to log in again, unless they change browsers, change computing devices, are idle for a predetermined period of time (e.g., two hours), etc. By using an authentication method like SSO, a user can be authenticated once early in the day, and keep accessing the system, application, etc. throughout the day without having to re-log in each time (e.g., via the landing page), saving time and reducing stress. In some embodiments, the authenticator 106 is setup and coordinated by the client system 102, the record management system 104, and/or service provider system 108.

Continuing with FIG. 1, the service provider system 108 can include any combination of systems that host third party applications or services to be utilized by the client system 102 and/or the record management system 104. In some embodiments, the service provider system 108 can be a system of a clinical laboratory that receives diagnostic testing orders to conduct tests on one or more specimen/samples. The tests on the one or more specimen/samples can include any combination of tests, analytics, diagnostic procedures, etc. For example, the tests can include medical tests to evaluate a patient's physical or mental health. For example, the tests can evaluate blood samples, tissue specimens, other biological materials, a psychological or physiological condition of the patient, physical fitness of the patient, etc. The medical tests can be conducted using any combination of systems or methods. For example, the medical tests can include physical measurement, electromechanical measurement, chemical measurement, user evaluation, etc. For purposes of this disclosure, the term medical tests will be used synonymously with any of these types of procedures.

In some embodiments, the clinical laboratory can include an accessioning and processing system for receiving, sorting, and processing the one or more specimen/samples for testing purposes. All of the received, stored, and derived information related to accession data, patient data, provider data, etc. can be stored in an accession database 114. In some embodiments, each diagnostic testing order, including tests on a specimen/sample, can be linked to an accession identifier. Similar to the record management system 104, the accession database 114 can include any combination of computing devices configured to store and organize a collection of data.

Once all testing associated with an accession identifier is completed, the clinical laboratory can provide results back to a requesting entity. For example, if a user on the client system 102 submitted the diagnostic testing order to the clinical laboratory (e.g., via service provider system 108), then the results can be provided to the user. The results can be provided to the requesting user using any combination of media. For example, the results can be provided via a web application interface, email, through the record management system 104, a short message service (SMS), an app push notification, physical mail, fax, etc. The results include any combination of test results, analytic results, diagnostic procedures results, etc. Additionally, the results can include various levels of details depending on the type of tests performed and information conveyed. For example, the results can include laboratory results, physiological results, mental results, physical results, etc. Additionally, the test results can be conveyed using any combination of informational presentations. For example, the test results can include any combination of measured values, expected values, graphs, color coding, detailed descriptions, etc. For purposes of this disclosure, the results will be used synonymously with any of these types of test results.

In some embodiments, the service provider system 108 can include an authorizer 116 configured to authorize a user to access a system, program, file, etc. For example, the authorizer 116 can ensure that a user (e.g., a physician) has access rights to an account that tests are ordered to or delivered to. The authorizer 116 can include any combination of authorization systems and methods. For example, the authorizer 116 can compare an authenticated identifier for a user against a list of unique identifiers associated with permissions to access a file. An example of such a comparison is whitelist, that includes a list of approved entities (e.g., Internet protocol (IP) address, email address, user credentials, applications, etc.) that are granted access to a system, program, file, etc. Alternatively, the authorizer 116 could maintain a list of entities that are explicitly not allowed to access a system, program, file, etc. An example would be a blacklist that includes a list of entities (e.g., Internet protocol (IP) address, email address, user credentials, applications, etc.) that are denied access to a system, program, file, etc.

In some embodiments, the authorizer 116 and the authenticator 106 can be provided by the same system and/or service provider. For example, the authenticator 106 and the authorizer 116 can be part of the service provider system 108 or part of a separate third-party service that coordinates the authentication and authorization of a user for the service provider system 108 In such instances, the third party-service may act as an intermediary between the client system 102 and the service provider system 108 to enable access to one or more resources provided by the service provider system 108. Alternatively, the service provider system 108, the authenticator 106, and the authorizer 116 can all be hosted and managed by different service providers. For example, the service provider system 108 can coordinate separately with an authenticator 106 service and an authorization servicer (e.g., authorizer 116) to provide a secure service to the client system 102. In some embodiments a single sign on (SSO) provider (e.g., authenticator 106) can perform the authentication and the authorization can be handled by service provider system 108. The SSO can be setup with an invitation through a provider portal accessible through an application programming interface (API) gateway.

Continuing with FIG. 1, in some embodiments, the service provider system 108 can include a resource reference generator 118. The resource reference generator 118 can be configured to generate a credential enabled reference that provides a location of a web resource associated with downloadable content for display. The credential enabled reference can include any combination of identifiers, addresses, etc. to direct a user to the downloadable content. In one example, the reference can be an immutable URL for a webpage that is specifically designed to include a particular file, such as a PDF containing test results included within an accession database. Each unique accession identifier in the accession database can include its own unique URL reference containing content for each of the test results included under the accession identifier. The unique accession identifier can be linked to one or more results (e.g., diagnostic test results).

In some embodiments, each credential enabled reference is uniquely associated with one or more users that are authorized to access the downloadable content on the webpage at the URL location. The authorized users can include any combination of users that would have permissions and/or privileges to access the downloadable content. For example, the authorized users can include lab technicians working on the diagnostic testing order associated with the accession identifier, healthcare practitioners that placed the diagnostic testing order, healthcare practitioners that are responsible for the patient, healthcare or lab administrators, or a combination thereof. The resource reference generator 118 can organize the credential enabled references in any combination of data structures that associate each credential enabled reference with a particular results file (e.g., downloadable content) and one or more authorized users. For example, the accession database can include a table linking each accession identifier (i.e., the downloadable content) with its own reference (i.e., URL) and associating each accession identifier with one or more users that are authorized to access the results displayed at the referenced web resource. In some embodiments, each URL and each reference can refer uniquely to one accession with no accession list or expansion of more services included. The information may be organized differently depending on the reference resource.

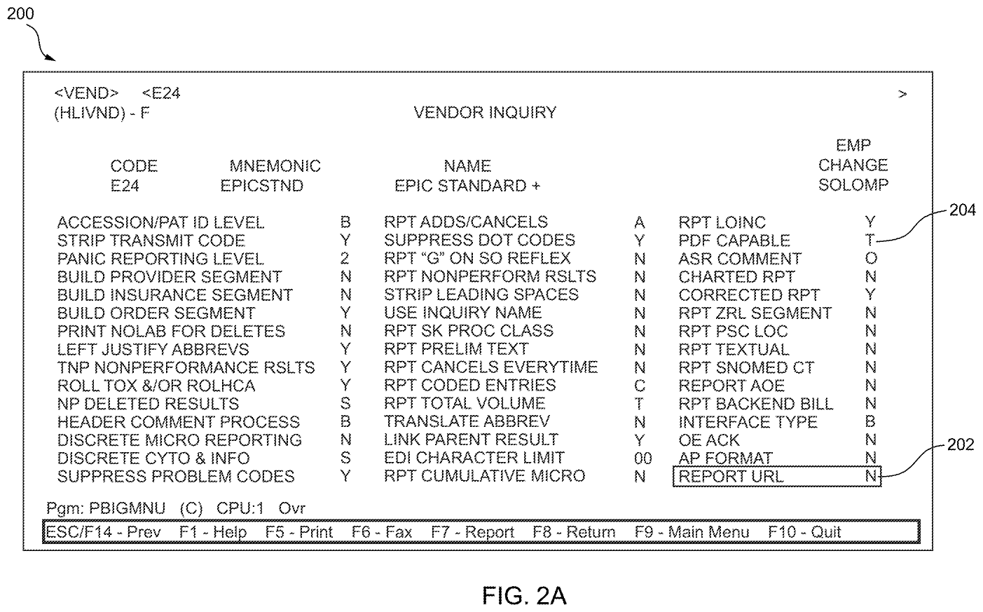

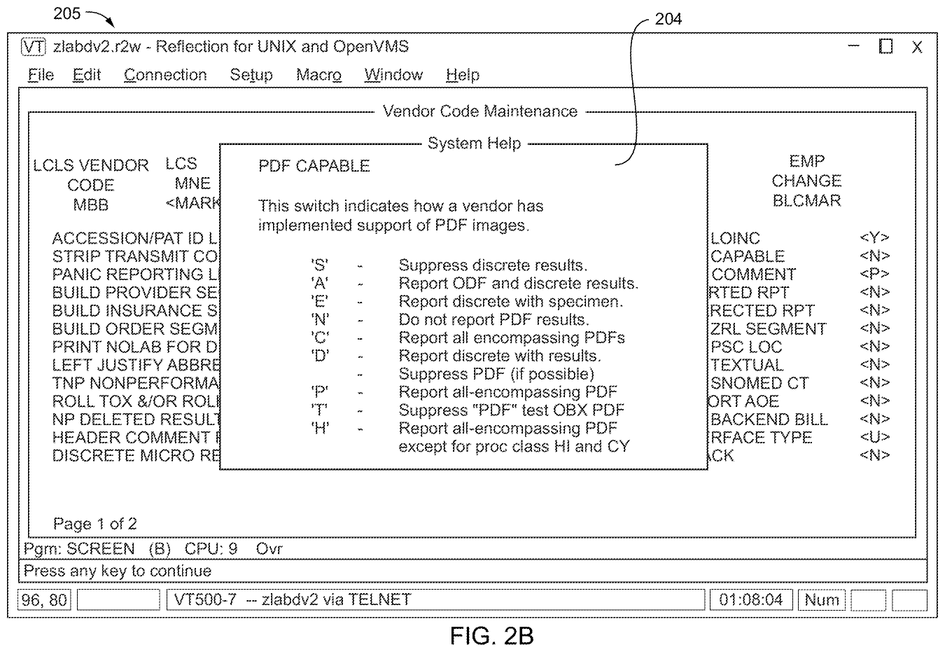

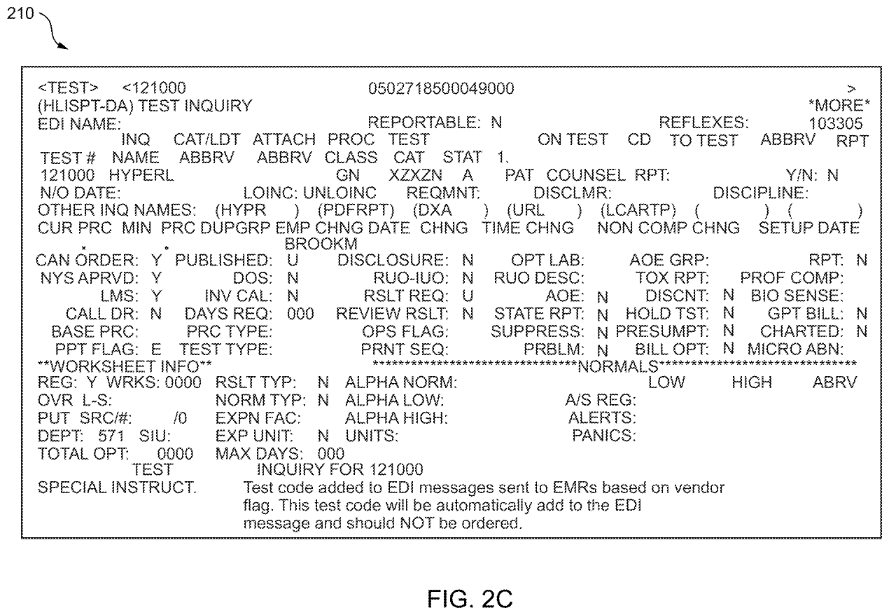

In some embodiments, the service provider system 108 can include an electronic data interchange engine 120. The electronic data interchange engine 120 can be configured to generate electronic reports (e.g., electronic data interchange files) to replace conventionally created paper reports and to automate paper-based transactions. The electronic data interchange files can be provided in standard computer friendly formats that satisfy specific specifications or requirements and may not be prohibitive in size. For example, the formats can include ANSI X12, EDIFACT, HIPAA, etc. The electronic data interchange engine 120 can also send electronic reports from one computer to another through a secure connection. The electronic reports can include any combination of information that is typically exchanged between the components of the system 100. In some embodiments, the electronic reports can include a report with minimal information and a reference to a web resource including additional information via downloadable content. For example, the service provider system 108 can use the electronic data interchange engine 120 to send diagnostic reports in electronic data interchange (EDI) messages to the client system 102, with each message including a unique immutable URL (e.g., within notes section of the EDI) linking the diagnostic results to a web resource displaying full results. The EDI messages may not report an actual PDF image, however, the messages may include an image comment that contains a pointer to the location of the PDF so that the receiving system (e.g., EMR/EHR) may retrieve the PDF. For example, based on a setting of a PDF Capable Switch, such as the switch discussed with respect to FIG. 2B, a comment may be sent. Advantageously, by providing messages to the client system 102 as EDI messages, the service provider system 108 can deliver content in a manner that is universally viewable by different computing devices without requiring specialized software for viewing. For example, the user may not need a PDF viewer on their local system (e.g., client system 102) to view a PDF file.

Each of the components within the system 100 can include a plurality of devices configured to communicate with one another over a communication network(s) 112. In some embodiments, the client system 102, the record management system 104, the authenticator 106, and the service provider system 108 are configured to establish a connection and communicate over communication network(s) 112 to carry out aspects of the present disclosure. As would be appreciated by one skilled in the art, the communication network(s) 112 can include any combination of known networks. For example, the communication network(s) 112 may be a combination of a mobile network, WAN, LAN, or other type of network. The communication network(s) 112 can be used to exchange data between the client system 102, the record management system 104, the service provider system 108, the authenticator 106, and/or to collect data from additional sources.

Continuing with FIG. 1, the combination of hardware and software that make up the system 100 can be specifically configured to provide a technical solution to a particular problem utilizing an unconventional combination of steps/operations to carry out aspects of the present disclosure. In particular, the system 100 can be designed to execute a unique combination of steps to provide a novel approach to deliver electronically viewable content to users without requiring the user to be encumbered by a large number of downloaded files, while still being able to efficiently access the desired information. The lack of downloadable files can also reduce a size and complexity for particular storage systems, such as for example, the record management system 104. Similarly, since the client systems 102 are not being encumbered by a large number of large files being downloaded, the system 100 can continue to run efficiently without being negatively affected by negative performance that may be caused by storage limitations.

FIGS. 2A and 2B depict example configuration screens 200 for configuring content sharing within a system 100 and for implementing steps in accordance with the aspects of the present disclosure. In particular, FIG. 2A depicts an example configuration screen 200 for setting up the system 100 to create and share a credential enabled reference or weblink for external resource access (e.g., downloadable content), as discussed in greater detail herein. The configuration screen 200 can be provided to any of the components within the system 100, depending on a preferred setup. For example, the configuration screen 200 can be provided to the client system 102, the record management system 104, the service provider system 108, or a combination thereof.

In some embodiments, the configuration screen 200 can include parameter entries that can be setup according to a specific vendor being served. For example, if an EMR/EHR system is capable of directly receiving downloadable content (e.g., PDFs), then a parameter entry 204 for PDF Capable can be toggled. If the parameter entry 204 for PDF Capable is toggled, then a reference link (to a webpage containing the PDF) can be provided to such EMR/EHR systems since the EMR/EHR systems can already receive the downloadable content directly. In such instances, a parameter entry 202 can be toggled to N (e.g., No), as depicted in FIG. 2A. In another example, if the parameter entry 204 for PDF Capable is toggled to N (e.g., No) then the parameter entry 202 can be toggled from N to Y (e.g., Yes) which indicates that the vendor can receive reference URLs, so that a reference link can be created and sent to the EMR/EHR system. The configuration screen 200 can include any combination of parameters to customize situations in which a reference link is created, content of the reference link (e.g., length, format, type, etc.), information describing how the reference link is provided to the client system 102, etc. In some instances, both the parameter entry 202 and the parameter entry 204 for PDF Capable can be toggled to yes to deliver both PDFs and reference links to a client device.

FIG. 2B depicts an example configuration screen 205 for setting up a parameter entry 204 for a PDF Capable switch for access by a client computing device (e.g., EMR/EHR systems). Examples of values for the PDF Capable switch are provided as: S—this setting can cause a reporting program to suppress optical broadband exchanges (OBXs) for test results that are represented in a PDF. A—a setting that reports PDF and discrete results to an integration platform, E—a setting to report discrete results with each specimen, N—a setting that does not report a PDF image comment, C—only reports the PDF image comment if the PDF is set up to be suppressed, P—causes a reporting program to report each specimen individually to ERG and to append a Base64 encoding to represent an entire specimen, T—suppresses a test OBX if a test name is “PDF” and a test inquiry name is “IMAGE” (suppressing the test OBX may not suppress the image comment), and H—sends all specimens to ERG (like the P option) except for Cytology and Histology specimens. The Cytology and Histology specimens can be sent to an integration platform (like in the A option). Any combination of settings can be implemented based on user and client preferences, and the examples provided with respect to FIG. 2B are not intended to be limiting.

FIG. 2C depicts an example sub-configuration screen 210 for creating or sharing a credential enabled reference or weblink for external resource access (e.g., downloadable content). For example, the credential enabled reference or weblink can be created or shared when a report URL parameter is enabled in configuration screen 200 of FIG. 2A. The configuration screen 210 can be provided to any of the components within the system 100 depending on a preferred setup. For example, the configuration screen 210 can be provided to client system 102, record management system 104, service provider system 108, or a combination thereof. When parameter entry 202 is toggled to Y (e.g., Yes) then the EMR/EHR system can be provided URLs associated with downloadable content. The configuration screen 210 can include any combination of parameters to customize situations in which a reference link is created, content of the reference link (e.g., length, format, type, etc.), a manner in which the reference link is provided to the client system 102, etc.

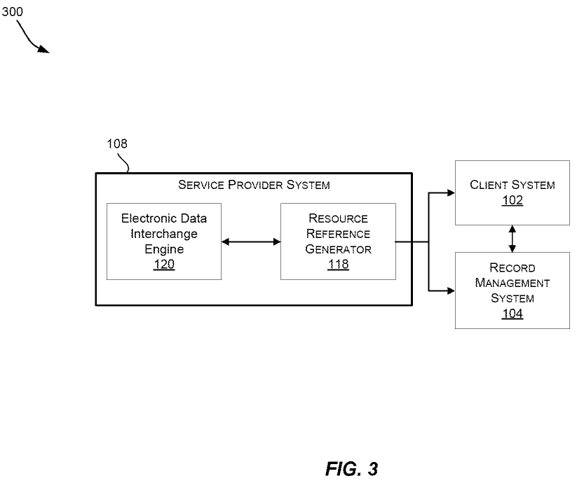

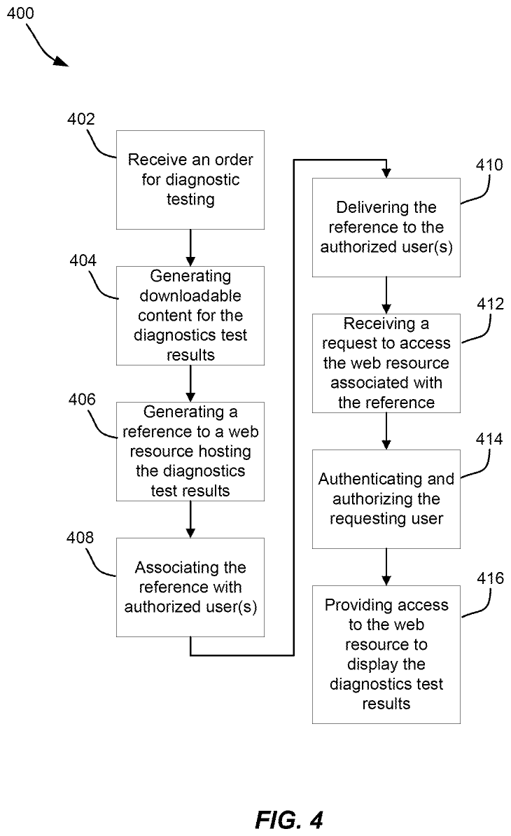

FIG. 3 is an illustrative diagram 300 depicting operation of system 100, in accordance with the aspects of the present disclosure. In particular, FIG. 3 is an illustrative diagram 300 for an example embodiment showing components allocated when creating and delivering a reference for access to a web resource having downloadable content thereon. In some embodiments, the components shown in FIG. 3 are used for generating and reporting test results from service provider system 108 and for electronic reporting of the test results to a client system 102, as discussed in greater detailed with respect to FIG. 4. In summary, the service provider system 108 can use a combination of electronic data interchange engine 120 and resource reference generator 118 to create an electronic reporting mechanism for ordering diagnostic tests by a client user. Thereafter, electronic reporting, including a reference, can be communicated to record management system 104 and/or directly to the client system 102.

FIG. 4 provides an example flow chart depicting a process 400 in accordance with the aspects of the present disclosure. In particular, FIG. 4 depicts an illustrative process 400 depicting components allocated, as depicted in FIG. 3, when creating and delivering a reference for a web resource having downloadable content thereon. The process 400 is discussed with respect to a laboratory service provider fulfilling a diagnostic test(s) order (associated with an accession identifier) for a healthcare practitioner and reporting results of the diagnostic testing order to the healthcare practitioner, however, the process 400 could be applied to any combination of industries and client/server relationships and is not intended to be limited to the examples provided herein.

At step 402, a diagnostic testing order, for one or more diagnostic tests, is received by service provider system 108. The diagnostic testing order can be received through any combination of methods known in the art. For example, a user (e.g., a healthcare practitioner) can create a diagnostic testing order for a specimen/sample, via the client system 102, within record management system 104. Thereafter, a specimen/sample can be obtained, a barcode can be affixed to the specimen/sample, and a label can be scanned for entry into the record management system 104. Entry of the specimen/sample within the record management system 104 can include identification for a patient, diagnostic tests for the specimen/sample, and any users that may be authorized to access the diagnostic test results. The record management system 104 type may impact how a result type of the URL is sent to the client system 102. For example, the URL may be a textual result or a result pointer. In some instances, the diagnostic tests for the specimen/sample can be performed by a third-party laboratory and provided to the service provider system 108 for the third-party laboratory. Once the specimen/sample is scanned, the diagnostic testing order can be placed with service provider system 108 to perform one or more tests (e.g., diagnostic assays) on the specimen/sample. In some embodiments, the diagnostic testing order is placed electronically with the service provider system 108 and the labeled specimen/sample can be physically delivered to an address for the third-party lab. Once the labeled specimen/sample is received at the physical location for the third-party lab, the service provider system 108 can validate the received specimen/sample and confirm the information on the specimen/sample label (e.g., scanning a barcode) with the information received electronically. Once the specimen/sample is received and validated, the requested tests can be processed by the laboratory and tracked in the service provider system 108.

In some embodiments, all received diagnostic testing orders are assigned a unique accession identifier. The accession identifier can be an identifier associated with all gathered results based on a particular collected specimen/sample. For example, if a blood sample for a particular patient is received with multiple different test panels to be conducted (e.g., glucose, BUN, Creatinine, eGFR, etc.), each of the different multiple test panels can be associated with the same unique accession identifier since the multiple test panels are all being conducted on the same blood sample. The accession identifier can be unique to a specific specimen/sample that was obtained, and all of the tests being conducted on that specific specimen/sample. In instances when different types of specimens/samples are received, each specimen/sample can be assigned a unique accession identifier. For example, if a blood sample and a tissue sample are received for the same patient, the blood sample (and corresponding tests of the blood sample) can be assigned a first accession identifier and the tissue sample (and corresponding tests of the tissue sample) can be assigned a second accession identifier. In another example, both the blood sample and the tissue sample can be assigned together under the first accession identifier. The accession identifiers can be automatically created, saved, managed, tracked, etc. using the service provider system 108.

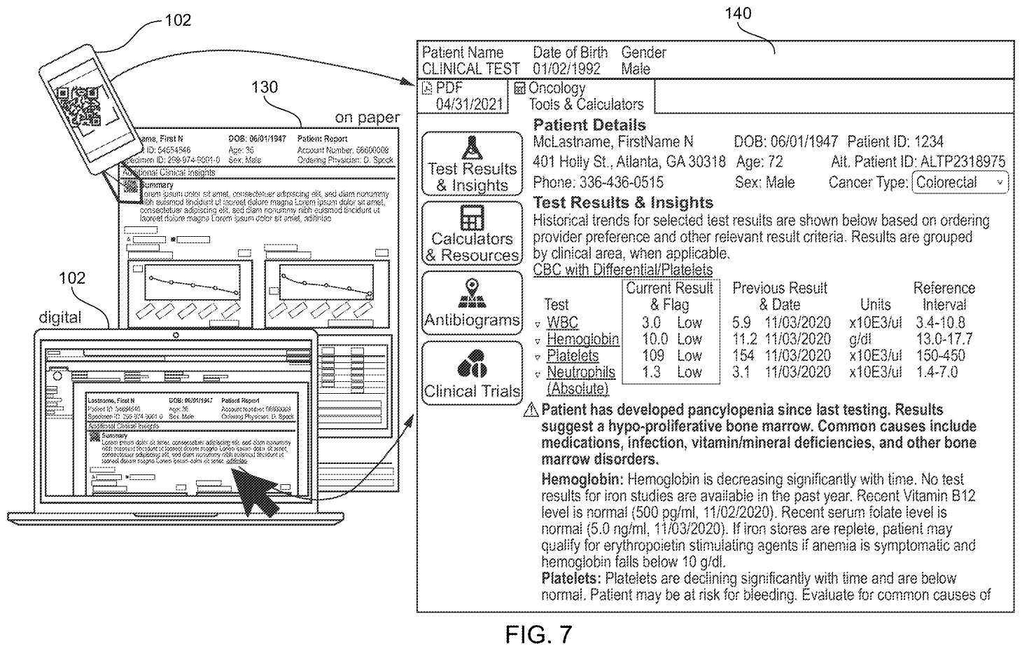

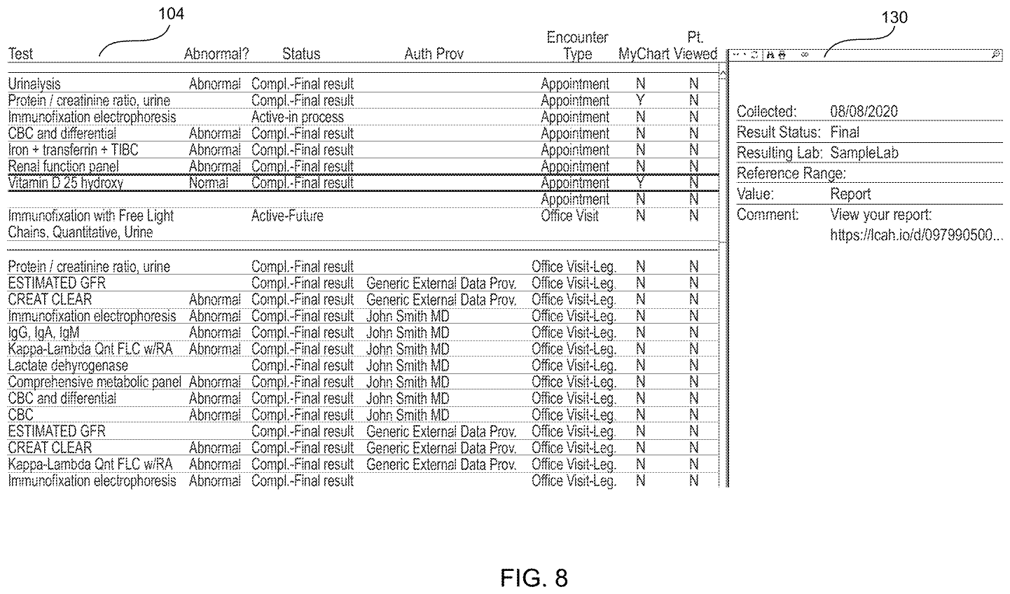

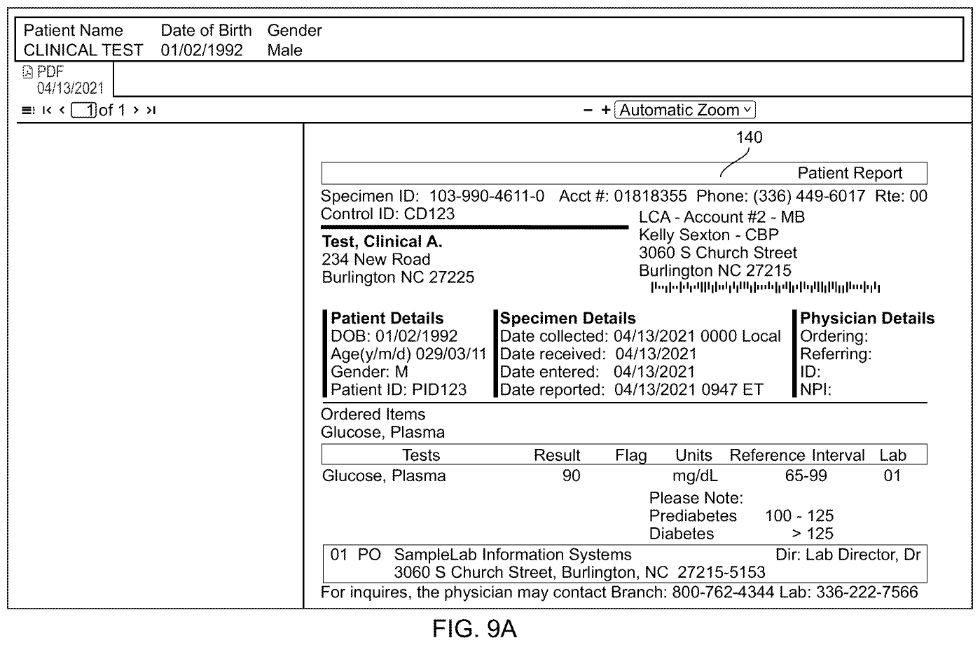

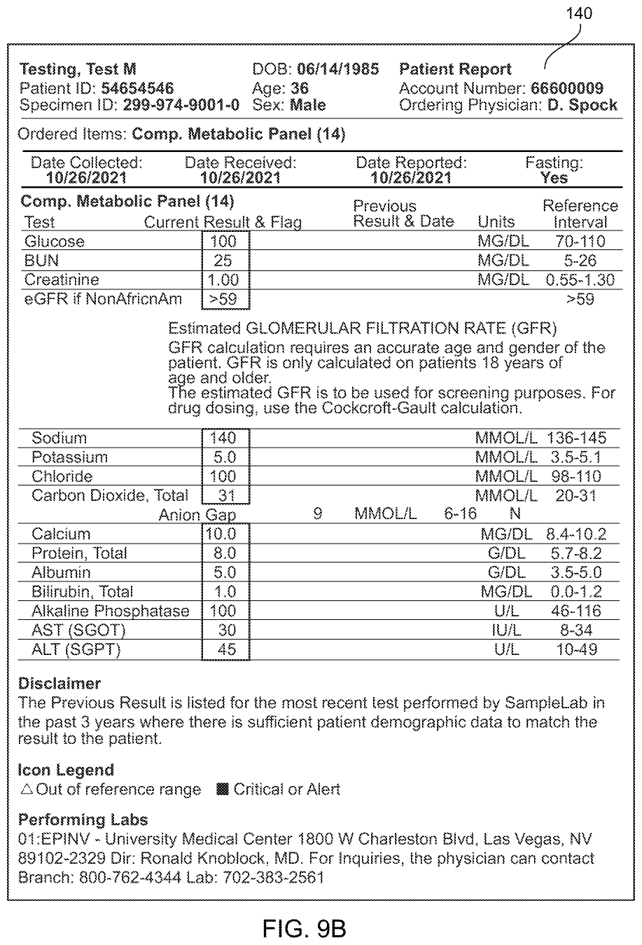

Once tests are completed for a particular accession identifier, test results can be aggregated and compiled into one or more reports, for example as depicted in FIGS. 7-9B. In some embodiments, the one or more reports can include a basic report 130 having basic information about diagnostic test results and a reference to a comprehensive report 140 (e.g., as shown in FIG. 7) and the comprehensive report 140 can have comprehensive information a break down and display of the test results (e.g., as shown in FIGS. 8, 9A, and 9B). The basic and comprehensive reports can include any combination of information including but not limited to information related to the healthcare practitioner, the patient, the testing facility/laboratory, the tests performed, the test results, etc. In some embodiments, a supplemental report(s) may be appended to the basic report 130 or the comprehensive report 140 depending on test orders. For example, a supplemental report(s) can be a clinical decision support (CDS) report(s), kidney stone report(s), laboratory services support report(s) within panels, etc. When a supplemental report(s) is included in the panel, the supplemental report can be appended to the comprehensive report, for example, at the end. In some embodiments, one or more of the reports can include CDS and/or an interpretation of lab results based on provided information (e.g., gender, age, etc.) and/or clinical guidelines. In some embodiments, the basic report 130 can be provided to a user in a simple uniform delivery format with a small footprint, whereas the comprehensive report 140 can be uploaded to a web resource for display to a user directed by a reference link included in the basic report 130.

At step 404, downloadable content displaying the test results is generated, for example, in the form of the basic report 130 and comprehensive report 140. In generating the basic report 130, the electronic data interchange engine 120 can be used to create the basic report 130. The basic report can have sufficient information to help summarize and explain to a user results. For example, as depicted in FIG. 7, the basic report 130 can include a date on which the specimen/sample was collected, a result status, the laboratory performing the test and providing the result, a comment field, etc. The electronic data interchange engine 120 can generate the basic report 130 in a manner that is uniformly deliverable and readable to conventional computing systems such that any users receiving the basic report 130 should be able to access and read the contents, for example, in the body of an email or a messaging center for an EMR/EHR. In some embodiments, the electronic data interchange engine 120 can deliver information for the basic report as American Standard Code for Information Interchange (ASCII) with an embedded Hypertext Markup Language (HTML) hyperlink, which can be visualized in an EHR. The EHRs can display the information provided by the electronic data interchange engine 120 differently depending on vendor/provider. Data can be stored in a similar manner as other discreet results managed in an EHR.

Continuing step 404, the service provider system 108 can create the comprehensive report 140 in a manner that is fully inclusive of all information provided for the tests. For example, as depicted in FIGS. 8, 9A, and 9B, the comprehensive report 140 can include all of the same information provided in the basic report 130 along with specific tests performed, the test results, ranges, test parameters, charts, graphs, etc. The comprehensive report 140 can also include patient and specimen/sample specific information and can be more detailed graphically with additional visualizations and colors. The comprehensive report 140 may not be limited to examples provided in FIGS. 8, 9A, and 9B and can include any format for reporting. For example, the comprehensive report 140 can include reports that are color coded, various charts and diagrams, greater detail summarizing the tests and the results, etc. The service provider system 108 can generate the comprehensive report 140 in any format that is suitable to contain and convey the information in the report. For example, the service provider system 108 can generate the comprehensive report 140 in a portable document file (PDF) that can be uploaded to a webpage for viewing by any user who has access to the webpage. Therefore, concluding step 404, multiple different test reports, with different levels of granularity, can be generated by the service provider system 108 and can be delivered to users using different methods (e.g., email, web resource publication, etc.)

At step 406, simultaneously or subsequently to generating one or more reports summarizing test results, the service provider system 108 generates an immutable reference associated with the accession identifier for the diagnostic testing order. Each diagnostic testing order that is received at the service provider system 108 can, at one time or another, be associated with an accession identifier and a unique immutable reference. The accession identifier can be used to track the diagnostic testing order throughout from reception to reporting, while the reference can be used to link the accession identifier to a location for displaying the comprehensive results associated with the accession identifier. The reference can include any combination of pathways or links to a location where the comprehensive report 140 can be stored for access. For example, the reference can be a URL address for a web resource such as a webpage (HTTP), file transfer (FTP), database access (JDBC), etc. The reference can also be embedded or otherwise include data that redirects a user to the unique reference address (e.g., the URL). For example, the reference can be included within a quick response code (QR code), barcode, etc.

In some embodiments, the resource reference generator 118 can generate the desired reference and can provide the reference to the electronic data interchange engine 120 to include the reference within the basic report 130. The resource reference generator 118 can generate a unique identifier in a form of a URL to a webpage that is an existing landing page. When the unique URL is selected, an authentication, authorization, and subsequent loading of an already generated PDF document can be initiated. If the already generated PDF document does not exist, the PDF document can be generated ad hoc. In some embodiments, in addition to generating the reference, the resource reference generator 118 may generate the web resource identified by the reference and provide the comprehensive report 140 to the web resource for display when the reference is followed. For example, the resource reference generator 118 generates a unique URL, then creates a webpage for the unique URL, and uploads the comprehensive report 140 (associated with the unique URL) to the webpage for viewing when the URL is accessed by an authorized and authenticated user. The reference can be generated using any combination of methods known in the art. For example, the reference can be specific and immutable, identifying the accession, the system of record, order, collection date, etc. Once generated, the reference can be included within the basic report 130 in a desired format. For example, the basic report 130 can be an electronic data interchange (EDI) deliverable that includes a note field that is updated to include a clickable URL or a scannable QR code including the URL.

At step 408, the reference created at step 406 is associated with one or more authorized users who are permitted to access the content linked to the reference. Authorization may be expected for every attempt to access the comprehensive report 140 (e.g., the PDF). The reference and the one or more authorized users can be linked using any combination of known methods. For example, the reference and the one or more authorized users can be associated to one another in a database, table, or other data structure (e.g., the accession database 114) The reference and the one or more authorized users can be associated in a manner in which when the reference is followed by a user, the user can be checked against the one or more authorized users to determine whether the user is permitted to view content associated with the reference, as discussed in greater detail herein. In some embodiments, the resource reference generator 118 can create the association between the reference and the one or more authorized users.

At step 410, the reference is provided to the appropriate users. For example, the reference is provided to the user who originally requested the diagnostic testing on the received specimen/sample. The reference can be provided to the appropriate users directly (e.g., through individual emails, portals, mobile apps, etc.) or indirectly (e.g., provided to an electronic record management system) for the user to access through a larger system or application. In some embodiments, the reference can be included as a selectable URL or scannable QR Code as part of a note or comment in the basic report 130. The basic report 130, with the reference included therein, can be delivered to the appropriate users using any preferred mode of communication. For example, the basic report 130 can be provided through an application, a web app, email, etc. In some embodiments, the electronic data interchange engine 120 provides the basic report 130 with the reference to the user. The basic report 130 can be delivered through any combination of secure communication means. For example, the basic report 130 can be encrypted, provided through a secure transmission channel, etc.

In some embodiments, the reference can be formatted and transmitted to satisfy one or more standards or requirements, depending on user and/or industry requirements. For example, when communicating with healthcare providers, there may be a requirement to communicate data according to a health level 7 (HL7) standard. Therefore, the reference itself and/or the basic report 130 including the reference can be formatted to enable communication of the information in accordance with the HL7 standard. The basic report 130 can also be formatted to accommodate such communications. For example, the basic report 130 can be communicated according to HL7 with NTE note segments (including the reference) as part of a message within the EMR/EHR. The resource reference generator 118 and the electronic data interchange engine 120 can work in combination to ensure that the data is formatted and transmitted properly to meet identified standards (e.g., HL7).

At step 412, once the one or more users have access to the reference and/or the basic report 130 including the reference, the service provider system 108 can begin receiving requests to access the content located at the web resource associated with the reference. For example, when a user selects a reference URL link, the service provider system 108 can receive a request to access a webpage associated with the reference URL, for example, the webpage hosting the comprehensive report 140. Since the content of the comprehensive report 140 can be protected and limited to those users who are authenticated and authorized, the user may first be verified, as discussed in greater detail with respect to step 414, before the system provides access to the comprehensive report 140. In other words, just because a user has access to the reference (e.g., a URL) does not mean the user is able to access the content associated with the reference location.

At step 414, the requesting user is authenticated and authorized. To provide the authentication and authorization of the user, prior to displaying or otherwise providing the web resource including the content associated with the reference to the user, the user can be redirected to a mechanism to provide necessary information to both authenticate and authorize the user for advancement to the web resource. In one embodiment, the user is redirected to a landing page or web resource access page 122 including inputs for the user to enter identification information such as user credentials. For example, the user can be redirected to a web resource access page 122 presenting the user with a login and password.

The authentication step can include confirming that the user has the proper credentials to access the service provider system 108. In some embodiments, the authentication can be performed by the authenticator 106. Continuing the example, the user can provide a username and a password, which will then be confirmed by the service provider system 108. The confirmation can include any combination of methods known in the art. For example, the service provider system 108 can reference the provider username and password against a database to confirm whether the user is a registered user, and the password is the proper password for the registered user's account. In another example, the service provider system 108 can hand off the information to a third-party to perform the authentication. For example, the service provider system 108 can provide the user credentials to a single sign on (SSO) service provider which will provide the authentication. If the authentication is approved, the SSO will return the results to the service provider system 108 for the next steps in the process 400. In some embodiments, the use of an authentication system such as SSO, allows a user to log in once to receive a token (e.g., stored in a browser 110) such that they do not need to relog into the service provider system 108 each time they want to access a file. For example, a user can log into the service provider system 108 during morning hours, and once authenticated, each time they access a different reference they can automatically be authenticated (e.g., using an embedded token) such that they are not redirected to a separate landing page to provide user login credentials. Automatic authentication can save the user from performing the redundant task of re-authenticating each time they want to access content within the service provider system 108.

The authorization step can include confirming that the user is one of the users permitted to access the content associated with the reference. In some embodiments, the authorization can be performed by the authorizer 116. To check to see if the user is authorized, the service provider system 108 can include any combination of methods known in the art. For example, the service provider system 108 can reference compare the user identity, as obtained during the authentication step, against the list of one or more users linked to the reference as authorized users for that content. If the authorization is approved, the service provider system 108 can allow access to the web resource associated with the reference. For example, once the user is authenticated and authorized, the user can be redirected to the original location of the reference (e.g., a webpage associated with a reference URL). If the user is an authorized user, the redirection can be performed seamlessly for the user. For example, once the user properly logs in, upon selection of a reference, the user can be directed to the content associated with the reference. If either the authentication or the authorization fails, then the user can be denied access to the reference and will not be able to view the downloadable content associated with the reference. For example, a denied user can be redirected to an error webpage or a webpage indicating that the user is not authenticated and/or authorized to view the selected content.

In some embodiments, as part of the authentication process, an application can check for a presence of information stored in a browser from a previous successful login. If the stored information is found, the login screen can be bypassed, and the user can be taken directly to the comprehensive report 140, provided the format and information of the URL is correct. Additional checks for permission to view the comprehensive report 140 can be made, but may not be a part of the authentication process. If the user has not previously logged in, has logged out, or the authentication information for the user has expired, the application can redirect the user to the login component and may not allow access to protected URL paths until the user has completed the authentication process.

The URL can include a reference to a resource router that controls what is displayed to the user through a screen. If authentication is given once, each subsequent call to the URL from the user can trigger an additional authentication process. But if an authentication token is still active within an authenticated user browser and the token has not expired (e.g. two hours of idle time has not elapsed), the authentication step can be bypassed by the token and just the URL resource and access authorization steps of the authentication process may be performed.

At step 416, access to the web resource that displays the comprehensive diagnostic test results, is provided to the user. Specifically, once a requesting user passes the authentication and authorization check for the reference being accessed, the user will be permitted to access the web resource to view the content thereon. For example, the user will be directed to webpage references by the reference URL link to view a PDF of the comprehensive diagnostic test results. As discussed herein, once a user is authenticated using a SSO, the user can access content on a web resource associated with a reference seamlessly by selecting the reference (e.g., clicking a URL) such that the authentication and authorization happens automatically and unknowingly to the user. At most, the user may be presented with a web resource access page 122 requesting the user to login for authentication purposes before being directed to the target reference location.

The steps in process 400 may enable a user to access and view protected and secured diagnostic test results in an efficient manner without having to burden the user's system with a large amount of data caused by large volumes of content (e.g., PDF files) delivered by the service provider system 108. Not only does the process 400 free up the user's own system (e.g., EMR/EHR) to be free of a source of large data encumbrances, but the process 400 can also provide a quickly accessible method for viewing comprehensive data from any source. For example, the user can universally access the URL using a terminal in the healthcare provider facility, access from a personal laptop at home, or access on their mobile device without having to worry about utilizing complicated remote access systems (e.g., virtual desktop, virtual private networks (VPN), etc.). Additionally, the process 400 can provide a method in which data can be shared in a secure manner in which only authorized and authenticated users can access specific content (e.g., test results).

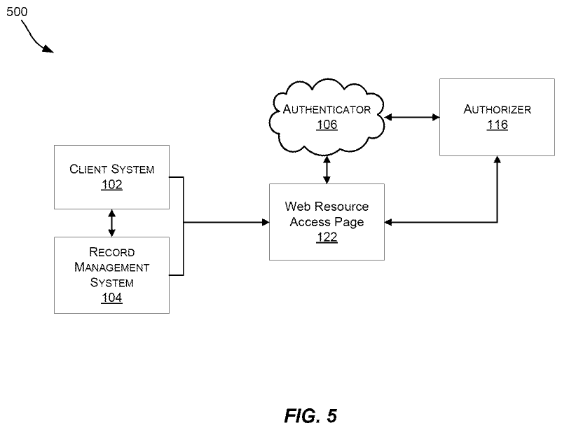

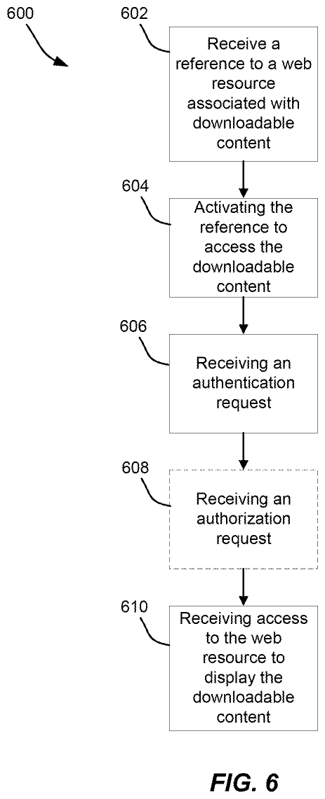

FIG. 5 depicts an illustrative diagram 500 depicting operation of a system in accordance with the aspects of the present disclosure. The system can be system 100 from FIG. 1. In particular, FIG. 5 depicts an illustrative diagram 500 showing an example embodiment including components allocated when a user attempts to access protected content hosted by a web resource. In some embodiments, the components shown in FIG. 5 are used for receiving a request (from a client system 102) to access content at a web resource, authenticating a user for access to the service provider system 108 hosting the web resource, and authorizing the user for permission to access the content of the web resource, as discussed in greater detailed with respect to FIG. 6. In summary, the service provider system 108 can provide a web resource access page 122 which can be used as an intermediary to the web resource, with the web resource access page 122 being used to gather information to authenticate and authorize the user for access to the web resource. The authentication can be performed by the authenticator 106 and the authorization can be performed by the authorizer 116. Each of the authenticator 106 and the authorizer 116 can be part of the service provider system 108 or the service provider system 108 can otherwise coordinate with third party services to perform the authentication and authorization of the user. In one example, the service provider system 108 can coordinate with a third-party cloud service of the authenticator 106 and host the authorizer 116, as shown in FIG. 5. Similarly, the web resource access page 122 can be hosted by the service provider system 108 or otherwise coordinated by the service provider system 108 with a third-party provider. Once authenticated and authorized, the user can access the web resource hosting the content. For example, the user can be permitted to access and redirected to the URL reference for a webpage displaying the content.

FIG. 6 provides an example flow chart depicting a process 600 in accordance with some aspects of the present disclosure. In particular, FIG. 6 depicts an illustrative process 600 showing operating steps for components, as depicted in FIG. 5, when receiving and activating a reference for access to a web resource having downloadable content thereon. The process 600 is discussed with respect to a laboratory service provider fulfilling a diagnostic testing order for a healthcare practitioner and reporting results of the diagnostic testing order to the healthcare practitioner, however, the process 600 could be applied to any combination of industries and client/server relationships and is not intended to be limited to the examples provided herein.

At step 602, a reference for access to a web resource associated with downloadable content is received. The reference can be received, for example, at a client system 102 or EMR/EHR system as part of a record management system 104. The reference can be received from a service provider system 108 executing step 410 of FIG. 4. In some embodiments, the reference is a URL for a webpage containing downloadable content, including for example, comprehensive diagnostic test results.

At step 604, the reference to access the downloadable content is activated by a user. Activation of the reference can include any action that will cause the activating system to be directed to a location or service referred to by the reference. Continuing the example, the reference could be a URL, that when selected, will cause a browser 110 to contact a domain associated with the URL and send a hypertext transfer protocol (HTTP) request to the domain server (e.g., LCAH.IO). Then the user may be routed to an appropriate resource. If the user activating the reference has previously been authenticated (e.g., through SSO) then the user may be directed to the web resource referenced, once authorized for the selected reference.

At step 606, an authentication request is received from the service provider system 108. For example, in response to sending the HTTP request to the domain, a request for authentication data is received. The request for authentication can include any combination of methods for verifying that the user is permitted to access the service provider system 108. In other words, confirming that the user has an account that has a username and password allowing the user to log into the service provider system 108.

In some embodiments, the authentication includes redirected the browser 110 to a web resource access page 122 with input fields for a username and password for access to the service provider system 108. In response to receiving the web resource access page 122, the user can enter their username and password. If the user is authorized, the process can continue to step 608, otherwise, the user may receive an error page indicating that the username and password does not match that of a user permitted to access the service provider system 108. In some embodiments, receiving the authentication request can include receiving, through the browser 110, a request for an authentication token. The authentication token can be associated with the browser 110 as part of an SSO (or similar) methodology in which a previous authentication of the user is accepted without having to re-enter the username and password. If an authorization token has been previously obtained, the browser 110 can automatically provide the token in response to the request for authentication and the web resource access page 122 can be skipped.

At step 608, optionally, an authorization request is received from the service provider system 108. For example, in response to providing proper authentication, a request for authorization data is received. The request for authorization can include any combination of methods for authorizing a user to verify that the user is permitted to access the content associated with the reference. In other words, authorizing determines whether the user is permitted to access the content requested. In some embodiments, the authorization is performed using at least some of the information provided during authentication, such that the user and/or user device does not receive a request for authorization. Instead, the authorization can be performed by the service provider system 108 using existing known information, such as for example, the username.

At step 610, once the user is authenticated and authorized, the user is provided access to the web resource to display the downloadable content. Continuing the above example, the access can be access to a webpage (with a URL of the reference) that includes downloadable content for a comprehensive diagnostic test report(s). As discussed herein, each reference can be uniquely associated with a URL/webpage and can have its own authentication and authorization parameters (e.g., different users can access different reference links). For example, each accessioning of a diagnostic test(s) received for a specimen/sample can have a unique URL associated therewith, as represented by the reference. In some embodiments, the access to the web resource to display the downloadable content can be provided through an application programming interface (API) integrated within a larger software suite or platform.

FIG. 7 depicts an illustrative example operation of the system and method of the present disclosure. In particular, FIG. 7 depicts an example implementation of the present disclosure for reporting diagnostic test results to a user, including a basic report 130 having a URL reference to a comprehensive report 140 hosted on a webpage. Initially, a basic report 130 can be received through any combination of mediums on any combination of devices for display to a user. As shown in FIG. 7, the basic report 130 can be a paper report received, for example, via mail, fax, etc. or the basic report 130 can be a digital report received on a computing device, for example, a computer, laptop, mobile device, etc. The computing device can be the client system 102. The received basic report 130 can include a combination of information that informs the user of what the report pertains to with a reference to a more detailed comprehensive report 140. As discussed herein, the reference can include any combination of visual or electronic structures that directs the user to another location where the comprehensive report 140 can be viewed. For example, the reference can be a link or URL to another program or webpage or the reference can be a scannable (e.g., barcode, QR Code, etc.) code that provides the reference location. When providing a scannable code, a user can use a secondary device to scan the reference to be redirected to the new location, as discussed in greater detail herein. For example, as shown in FIG. 7, a user can use a client system 102 to scan a QR Code on the basic report 130 to be redirected to the webpage containing the comprehensive report 140. The QR Code can be presented on a digital report or a paper report.

FIG. 8 depicts an illustrative example operation of the system and method of the present disclosure. In particular, FIG. 8 illustrates an example user interface that may be found in an EMR/EHR system for an electronic data interchange (EDI) delivery of a basic report 130. In some embodiments, users can receive messages including previously ordered diagnostic testing results, with each of the messages including a unique reference. These messages, as shown in FIG. 8, can take a form of simple EDI text deliveries (e.g., as provided by the electronic data interchange engine 120) with an HL7 delivery. The HL7 can provide a HIPAA compliant access and delivery. The messages shown can be considered basic reports 130, reporting that the test is complete and providing a secure reference to access the comprehensive report 140. As would be appreciated by one skilled in the art, the appearances and preferred format of the basic report 130 messages can vary between EMR/EHR vendors (or other industry message delivery programs). Most EMRs can make the URL clickable, such that the user clicking on the URL will open a new browser 110 window to initiate step 604 in FIG. 6.

FIGS. 9A and 9B illustrate examples of a comprehensive report 140 as part of a diagnostic testing order for a specimen/sample. In some embodiments, the comprehensive report 140 is a PDF document uploaded to a webpage located at a unique reference URL. The PDF document for the comprehensive report 140 can include more detailed information about the healthcare provider, patient, testing facility/laboratory, the tests performed, the test results, etc. that may not be included in the basic report 130. Specifically, the information excluded from the basic report 130 and included in the comprehensive report 140 can include any combination of personal, private, protected, or information that otherwise is only intended for a particular class of user (e.g., authorized and authenticated) to be able to access. For example, the comprehensive report 140 can include any combination of personal, private, protected, or information that otherwise is only intended to be viewed by a healthcare practitioner that is providing care to a patient, such that non-treating healthcare practitioners or non-practitioners would not be able to view the information, even if the non-treating healthcare practitioners or non-practitioners had access to the EMR/EHR/service provider system 108 and/or the URL address. As discussed herein, to access the comprehensive report, the user needs to be both authenticated (e.g., a user who has access to the EMR/EHR/service provider system 108 or other program providing the information) and authorized (e.g., a user who is permitted to view that specific report).

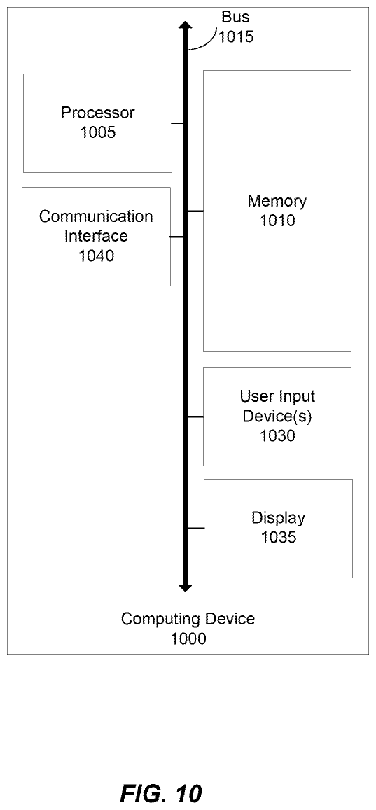

FIG. 10 illustrates an example computing device 1000 suitable for use with systems and methods for generating credential enabled reference links for external resource access, including downloadable content, according to this disclosure. The example computing device 1000 includes a processor 1005 which is in communication with the memory 1010 and other components of the computing device 1000 using one or more communications buses 1015. The processor 1005 is configured to execute processor-executable instructions stored in the memory 1010 to perform one or more methods according to different examples, such as part or all of the example processes 400, 600 described above with respect to FIGS. 4 and 6. In this example, the memory 1010 stores processor-executable instructions that provide the various components and their related functionality, as discussed above with respect to FIGS. 1-9B. The computing device 1000, in this example, also includes one or more user input devices 1030, such as a keyboard, mouse, touchscreen, microphone, etc., to accept user input. The computing device 1000 also includes a display 1035 to provide visual output to a user such as a user interface.

The computing device 1000 also includes a communications interface 1040. In some examples, the communications interface 1040 may enable communications using one or more networks, including a area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an algorithm-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

### ADDITIONAL CONSIDERATIONS

Although specific examples have been described, various modifications, alterations, alternative constructions, and equivalents are possible. Examples are not restricted to operation within certain specific data processing environments but are free to operate within a plurality of data processing environments. Additionally, although certain examples have been described using a particular series of transactions and steps, it should be apparent to those skilled in the art that this is not intended to be limiting. Although some flowcharts describe operations as a sequential process, many of the operations may be performed in parallel or concurrently. In addition, the order of the operations may be rearranged. A process may have additional steps not included in the figure. Various features and aspects of the above-described examples may be used individually or jointly.

Further, while certain examples have been described using a particular combination of hardware and software, it should be recognized that other combinations of hardware and software are also possible. Certain examples may be implemented only in hardware, or only in software, or using combinations thereof. The various processes described herein may be implemented on the same processor or different processors in any combination.

Where devices, systems, components or modules are described as being configured to perform certain operations or functions, such configuration may be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes may communicate using a variety of techniques including but not limited to conventional techniques for inter-process communications, and different pairs of processes may use different techniques, or the same pair of processes may use different techniques at different times.

Specific details are given in this disclosure to provide a thorough understanding of the examples. However, examples may be practiced without these specific details. For example, well-known circuits, processes, algorithms, structures, and techniques have been shown without unnecessary detail in order to avoid obscuring the examples. This description provides example examples only, and is not intended to limit the scope, applicability, or configuration of other examples. Rather, the preceding description of the examples will provide those skilled in the art with an enabling description for implementing various examples. Various changes may be made in the function and arrangement of elements.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific examples have been described, these are not intended to be limiting. Various modifications and equivalents are within the scope of the following claims.

In the foregoing specification, aspects of the disclosure are described with reference to specific examples thereof, but those skilled in the art will recognize that the disclosure is not limited thereto. Various features and aspects of the above-described disclosure may be used individually or jointly. Further, examples may be utilized in any number of environments and applications beyond those described herein without departing from the broader spirit and scope of the specification. The specification and drawings are, accordingly, to be regarded as illustrative rather than restrictive.

In the foregoing description, for the purposes of illustration, methods were described in a particular order. It should be appreciated that in alternate examples, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMS, EPROMs, EEPROMs, magnetic or optical cards, flash memory, or other types of machine-readable mediums suitable for storing electronic instructions. Alternatively, the methods may be performed by a combination of hardware and software.

Where components are described as being configured to perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

While illustrative examples of the application have been described in detail herein, it is to be understood that the inventive concepts may be otherwise variously embodied and employed, and that the appended claims are intended to be construed to include such variations, except as limited by the prior art.

What is claimed is:

1. A method for external resource access, the method comprising:
receiving, by a service provider, a diagnostic testing order for performing one or more tests;
generating, by the service provider, downloadable content displaying test results obtained from performing the one or more tests;
generating, by the service provider, a reference to a web resource including the downloadable content;
associating, by the service provider, the reference with one or more authorized users permitted to access the test results;
delivering, by the service provider, the reference for access by the one or more authorized users;
receiving, by the service provider, a request from a requesting user for access to the web resource associated with the reference;
authenticating, by the service provider, an identity of the requesting user;
authorizing, by the service provider, the requesting user; and
providing, by the service provider, access to the web resource displaying the downloadable content for the test results to the authenticated and authorized user.

2. The method of claim 1, wherein generating the reference to the web resource comprises generating a uniform resource locator (URL) for the web resource having the downloadable content.

3. The method of claim 2, wherein receiving the request for access to the web resource associated with the reference comprises receiving request to access a webpage associated with the reference URL.

4. The method of claim 2, wherein providing access to the web resource displaying the downloadable content for the test results to the authorized user comprises re-directing a web browser to the URL for the web resource having the downloadable content.

5. The method of claim 1, wherein generating downloadable content displaying test results obtained from performing the one or more tests comprises generating a basic report including the reference and basic information about the test results.

6. The method of claim 1, wherein delivering the reference for access by the one or more authorized users comprises transmitting the reference to an account associated with the one or more authorized users within an electronic medical record (EMR) system.

7. The method of claim 1, wherein generating the downloadable content comprises generating a graphical user interface (GUI) comprising a plurality of graphical elements, the plurality of graphical elements comprising a test results and insights icon.

8. A system for a service provider comprising:
one or more processors; and
one or more memories that include instructions executable by the one or more processors to perform operations comprising:
receiving a diagnostic testing order for performing one or more tests;
generating downloadable content displaying test results obtained from performing the one or more tests;
generating a reference to a web resource including the downloadable content;
associating the reference with one or more authorized users permitted to access the test results;
delivering the reference for access by the one or more authorized users;
receiving a request from a requesting user for access to the web resource associated with the reference;
authenticating an identity of the requesting user;
authorizing the requesting user; and
providing access to the web resource displaying the downloadable content for the test results to the authenticated and authorized user.

9. The system of claim 8, wherein the operation of generating the reference to the web resource comprises generating a uniform resource locator (URL) for the web resource having the downloadable content.

10. The system of claim 9, wherein the operation of receiving the request for access to the web resource associated with the reference comprises receiving request to access a webpage associated with the reference URL.

11. The system of claim 9, wherein the operation of providing access to the web resource displaying the downloadable content for the test results to the authenticated and authorized user comprises re-directing a web browser to the URL for the web resource having the downloadable content.

12. The system of claim 8, wherein the operation of generating downloadable content displaying test results obtained from performing the one or more tests comprises generating a basic report including the reference and basic information about the test results.

13. The system of claim 8, wherein the operation of delivering the reference to the one or more authorized users comprises transmitting the reference to an account for the one or more authorized users within an electronic medical record (EMR) system.

14. The system of claim 8, wherein the operation of generating the downloadable content comprises generating a graphical user interface (GUI) comprising a plurality of graphical elements, the plurality of graphical elements comprising a test results and insights icon.

15. A non-transitory computer-readable medium comprising instructions that are executable by one or more processing devices for causing the one or more processing devices to perform operations comprising:
receiving a diagnostic testing order for performing one or more tests;
generating downloadable content displaying test results obtained from performing the one or more tests;
generating a reference to a web resource including the downloadable content;
associating the reference with one or more authorized users permitted to access the test results;
delivering the reference for access by the one or more authorized users;
receiving a request from a requesting user for access to the web resource associated with the reference;
authenticating an identity of the requesting user;
authorizing the requesting user; and
providing access to the web resource displaying the downloadable content for the test results to the authenticated and authorized user.

16. The non-transitory computer-readable medium of claim 15, wherein the operation of generating the reference to the web resource comprises generating a uniform resource locator (URL) for the web resource having the downloadable content.

17. The non-transitory computer-readable medium of claim 16, wherein the operation of receiving the request for access to the web resource associated with the reference comprises receiving request to access a webpage associated with the reference URL.

18. The non-transitory computer-readable medium of claim 16, wherein the operation of providing access to the web resource displaying the downloadable content for the test results to the authenticated and authorized user comprises re-directing a web browser to the URL for the web resource having the downloadable content.

19. The non-transitory computer-readable medium of claim 15, wherein the operation of generating downloadable content displaying test results obtained from performing the one or more tests comprises generating a basic report including the reference and basic information about the test results.

20. The non-transitory computer-readable medium of claim 15, wherein the operation of delivering the reference to the one or more authorized users comprises transmitting the reference to an account for the one or more authorized users within an electronic medical record (EMR) system.
